(19) United States
(12) Patent Application Publication
(10) Pub. No.: US 2011/0213588 A1
(43) Pub. Date: Sep. 1, 2011

(54) SYSTEM AND METHOD FOR OCCUPANCY ESTIMATION AND MONITORING

(75) Inventors: Yiqing Lin, Glastonbury, CT (US); Stella M. Oggianu, Manchester, CT (US); Amit Surana, East Hartford, CT (US); Sean Meyn, Farmington, CT (US); Igor I. Fedchenia, West Hartford, CT (US)

(73) Assignee: UTC FIRE & SECURITY, Farmington, CT (US)

(21) Appl. No.: 13/126,519

(22) PCT Filed: Nov. 7, 2008
(86) PCT No.: PCT/US2008/012580

§ 371 Date: Apr. 28, 2011

(51) Int. Cl. G06F 17/18; G06F 15/00

(52) U.S. Cl. 702/181; 702/179; 702/189

(57) ABSTRACT

A system computes occupancy estimates based on one or more inputs, including sensor data from one or more sensor devices, constraints on allowable occupancy levels, and one or more utility functions. An occupancy estimator organizes the sensor data, the utility functions and an occupancy estimate into an objective function and executes a constrained optimization algorithm that computes the occupancy estimate, subject to the constraints, such that the objective function is minimized. The computed occupancy estimate is provided as an output by the system to one or more control and/or monitoring systems.

### BACKGROUND

The present invention is related to a system and method for estimating and monitoring occupant movements.

Information regarding the occupancy of a particular region can be useful in a variety of applications. For instance, the presence and location of occupants within a building can be used to improve the efficiency, comfort, and convenience of a building. Typically, building occupancy is determined based solely on data provided by sensors. These occupancy estimates may result in the generation of errors due to sensor malfunctions and/or the accumulation of errors in the sensor data over time.

In addition, information regarding how occupants move within a building may be beneficial. Such information may include typical behavior regarding occupant movement in a particular region at a particular point in time.

### SUMMARY

A system for monitoring occupancy in a region includes a first input operably connected to receive sensor data from one or more sensor devices, a second input operably connected to receive one or more constraints, and a third input operably connected to receive a utility function. An occupancy estimator is operably connected to the inputs to receive sensor data, constraints, and the utility function. The occupancy estimator organizes the sensor data, the utility function, and an occupancy estimate into an objective function and executes a constrained optimization algorithm that computes the occupancy estimate, subject to the constraints, such that the objective function is minimized. An output is operably connected to the occupancy estimator to communicate the computed occupancy estimate.

In another aspect, a method of monitoring occupancy in a region includes acquiring sensor data from one or more sensor devices and computing an occupancy estimate, that minimizes a result of an objective function. The objective function is organized to compare a penalty associated with differences in the sensor data and the occupancy estimate with a utility function that describes a likely occupancy level. The occupancy estimate computed to minimize the result of the objective function is provided as an output to one or more control and/or monitoring systems.

In another aspect a system generates occupancy estimates and conditional probability distributions defining occupant movements in a region. The system includes at least one sensor device for acquiring sensor data relevant to occupancy. The system further includes means for generating an occupancy estimate, means for calculating a parameter estimate, and means for generating a conditional probability distribution. The means for generating an occupancy estimate executes a constrained optimization algorithm in conjunction with an objective function organized to compare the sensor data to the occupancy and/or flow estimate. The constrained optimization algorithm computes the occupancy estimate and/or flow estimate to minimize the result of the objective function, subject to a plurality of constraints on allowable levels of occupancy. The means for calculating a parameter estimate calculates an arrival parameter estimate associated with arrival of occupants to a zone with the region by applying a first statistical distribution to one or more calculated occupancy estimates and/or flow estimates. The means for calculating a parameter estimate further calculates a transition parameter estimate associated with transition of occupants between zones within the region by applying a second statistical distribution to one or more calculated occupancy estimates and/or flow estimates. The means for generating a conditional probability distribution applies a parameterized Markov model to the parameter estimates to generate a conditional probability distribution that represents a probability of a particular zone within the region having various levels of occupancy at a current time step, conditioned on an occupancy estimate of the particular zone and zone neighboring the particular zone at a previous time step.

In another aspect a computer readable storage medium is encoded with a machine-readable computer program code for generating occupancy estimates for a region and a conditional probability distribution describing normal occupant traffic for a region, the computer readable storage medium including instructions for causing a controller to implement a method. The computer program includes instructions for acquiring input from one or more sensor devices. The computer program also includes instructions for computing an occupancy estimate that minimizes a result of an objective function, wherein the objective function is organized to compare a penalty associated with differences in the sensor data and the occupancy estimate with a utility function that describes a likely occupancy level. The computer program also includes instructions for generating an output that provides the occupancy estimate to selected systems within the region.

### BRIEF DESCRIPTION OF THE DRAWINGS

FIG. 1A is a schematic of a floor of a building divided into a number of zones.

FIG. 1B is a diagram modeling entrances to each zone of the building floor.

FIG. 2 is a flowchart illustrating the calculation of occupancy estimates, flow estimates, and occupant traffic distributions based on a variety of inputs according to an embodiment of the present invention.

FIG. 3 is a block diagram of a centralized occupancy estimation system.

### DETAILED DESCRIPTION

Disclosed herein is a system and method for estimating occupancy within a region and for generating a conditional probability distribution based on accumulated occupancy estimates that model normal occupant traffic in the region. In particular, occupancy estimates are generated by an occupancy estimator based on data provided by sensor devices, one or more constraints associated with occupancy and flow of occupants, and prior information regarding sensor models, information regarding how individual zones or rooms are to be utilized, and/or specific knowledge regarding expected occupancy at a given time. The occupancy estimator executes a constrained optimization algorithm to compute a most likely estimate of occupancy (i.e., number of occupants located in each zone) and flow (i.e., number of occupants transitioning between zones) based on provided sensor data, constraints, and utility information. Estimates of occupancy and flow can be provided as inputs to a variety of systems, such as heating, ventilation, and air-conditioning (HVAC) systems, elevator dispatch systems, lighting control systems, etc. for improved, efficient control of a building environment.

In addition, occupancy and flow estimates can be provided as an input to generate a statistical model that describes the traffic patterns of occupants within the region. The statistical model is useful in a variety of applications. For example, the distribution may be used for forensic purposes to understand how occupants move within a building (i.e., building intelligence), or can be used in real-time to determine whether the movement of occupants within the region represents “abnormal” conditions.

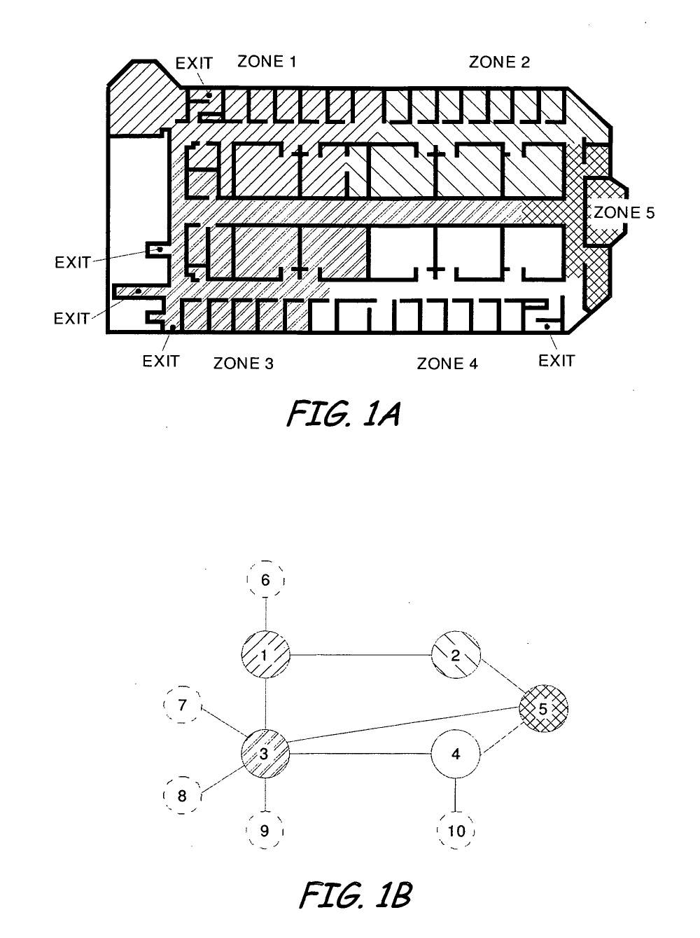

FIGS. 1A and 1B illustrate an example that will be used throughout this description to aid in describing the occupancy estimation system, in which occupancy estimations and occupant traffic distributions are made for a particular floor of a building. The concepts described with respect to this embodiment could be applied in a variety of settings or locations (e.g., outdoors, train stations, airports, etc.). FIG. 1A illustrates the layout of a single floor in an office building. In this example, the floor plan has been divided into five separate zones (labeled zones 1, 2, 3, 4 and 5). In other cases, the floor plan could be further sub-divided based on the location of individual offices and rooms (i.e., site-based sub-divisions). A plurality of heterogeneous sensors (not shown) are distributed throughout the floor to form a distributed network of sensors for providing information regarding occupancy and/or flow. Types of sensors employed as part of this distributed network may include motion detection sensors such as passive infrared (PIR) sensors, video cameras, and carbon-dioxide (CO2) sensors. In addition, other systems throughout the building may be used to provide information regarding the presence of an occupant in a particular room or zone based on whether the system is currently in use. For example, passive devices such as telephones, elevator call buttons, and light switches can be used to provide information regarding whether the room is occupied based on whether the device is in use. Similarly, active devices such as employee keycards or RFID devices may be employed as sensors to provide information regarding the location and movement of occupants.

FIG. 1B is a diagram illustrating the five zones defined in FIG. 1A. The large circles labeled 1, 2, 3, 4 and 5 represent the five zones, and the smaller circles labeled 6, 7, 8, 9 and 10 represent the exits from the building. The lines connecting zones indicate the presence of passages or hallways connecting adjacent zones.

The term ‘region’ is used throughout the description to refer to both a region as well as various sub-divisions of the region. For instance, in the exemplary embodiment shown in FIGS. 1A and 1B, the term ‘region’ refers to both the floor plan in general as well as to the individual sub-regions or zones 1-5. Therefore, generating an occupancy estimate for the region would include generating occupancy estimates for each of the individual zones. In other embodiments, generating an occupancy estimate includes generating occupancy estimates for each individual room and/or hallway. Similarly, generating flow estimates for a region would include generating an estimate describing the number of occupants entering and/or exiting the region as well as the number of occupants moving between adjacent zones.

In addition, the term ‘occupancy estimate’ is used throughout the description and refers generally to any output related to occupancy. For example, an occupancy estimate for a region may include data such as a mean estimate of the number of occupants within the region, a probability associated with all possible occupancy levels associated with the region, changes in occupancy, estimates of variance and other indicators of the reliability or confidence associated with an estimate of occupancy, as well as other similarly useful data related to occupancy. Therefore, in the example shown in FIGS. 1A and 1B an occupancy estimate generated for a region would include any of the above-listed data generated for each of the zones 1-5. The term ‘flow estimate’ is similarly used throughout the description and refers generally to any output related to the flow of occupants between adjacent regions. This may include data such as a mean estimate of the number of occupants moving between adjacent regions, a probability associated with all possible occupant flow values associated with different regions, changes in flow, estimates of variance and other indicators of the reliability or confidence associated with an estimate of flow, as well as similarly useful data related to the movement of occupants between zones or regions.

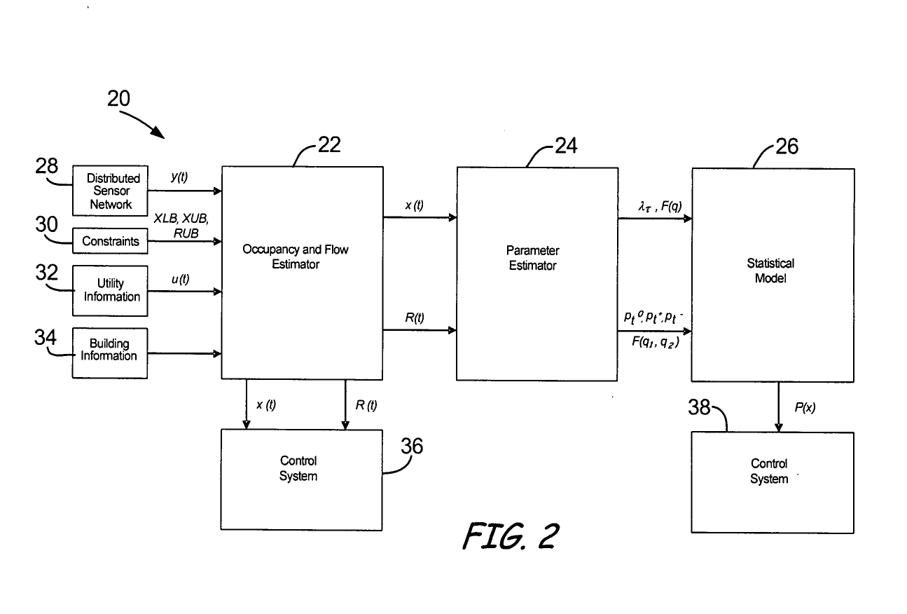

FIG. 2 is a block diagram illustrating occupant estimation system and monitoring 20 according to an embodiment of the present invention. System 20 includes occupancy and flow estimator (referred to simply as “occupancy estimator”) 22, parameter estimator 24, and statistical model 26. Occupancy estimator 22 includes inputs for receiving sensor data y(t) from a plurality of heterogeneous sensors 28, one or more constraints 30, utility information 32, and building information 34, each described in more detail below.

Based on these inputs, occupancy and flow estimator 22 generates real-time occupancy estimates x(t) and flow estimates R(t) (i.e., representing the movement of occupants within a region). Occupancy estimates x(t) and flow estimates R(t) are provided as real-time data to control systems 36, which may include a variety of individual systems, including HVAC systems, elevator control systems, lightning systems, and/or egress support systems.

The occupancy estimates x(t) and flow estimates R(t) generated by occupancy estimator 22 are additionally provided to parameter estimator 24. Based on these inputs, parameter estimator 24 generates parameter estimates (e.g., arrival rate λ_{T}, probabilities of transitioning between zones p_{T}⁰, p_{T}⁺, p_{T}⁻) that are used to construct the statistical model of occupant arrivals and transitions between zones. In response to the estimated parameters, statistical model 26 generates a conditional probability distribution P(Xᵢ), i=1, 2, . . . N (N is total number of zones) that describes the traffic pattern throughout the region. More precisely P(Xᵢ) denotes the conditional probability of zone i taking different values of occupancy given the occupancy levels in zone i and its neighboring zones at previous time step. Letting Nᵢ denote the set of neighbors of zone i, including itself, then Xᵢ given by

Xᵢ=xᵢ¹|{xⱼ⁰: jεNᵢ} Eq. 1

where, the superscripts 0 and 1 denote the previous and current time step, respectively. The conditional probability distribution P(X) can be used for both real-time and forensic applications. For instance, the conditional probability distribution can be compared with a conditional probability distribution based on previously-observed distribution, or programmed distributions to detect in real-time anomalous conditions indicative of security threats. In addition, the conditional probability distribution can be used for forensic purposes to understand how occupants move within a region. This may be particularly beneficial for commercial buildings in which information regarding occupant movements can be used to improve marketing to potential customers.

In an exemplary embodiment, sensor data y(t), occupancy estimates x(t), flow estimates R(t), and utility functions u(t) are represented as vectors, although in other exemplary embodiments these values may be represented in other useful formats. For instance, sensor data y(t) may be represented as a vector of data collected from each sensor in distributed sensor network 28.

As discussed above, heterogeneous sensor network 28 may include a plurality of sensor types, including passive infrared (PIR) sensors, video cameras, and carbon-dioxide (CO2) sensors. In addition, other passive and active systems throughout the building (e.g., telephones, keyboards, elevator call buttons, keycards, etc.) may be included with sensor network 28 to provide information regarding the presence or indicated movement of occupants. The information gathered by each sensor may be processed by the sensor itself, or may be provided as raw data that is processed by estimation system 20. Processing of the sensor data takes into account the different types of information provided by different types of sensors. For instance, processing of video data may provide information regarding a specific number of occupants transitioning between zones or a specific number of occupants located in a particular room or zone. In contrast, PIR sensors only provide binary information regarding whether or not a room is occupied, not the number of occupants in the room. In this case, some processing to determine how to interpret data from a PIR sensor indicating the presence of an occupant (i.e., number of occupants to associate with the room) is typically required. Sensor data y(t) may therefore encompass both raw sensor data, as well as processed sensor data indicating occupant location as well as occupant transitions between zones. In other embodiments, information regarding how to interpret sensor data provided by a number of heterogeneous sensors may be incorporated within utility function u(t).

User-defined constraints 30 represent rules or conditions that must be satisfied as part of the constrained optimization function performed by occupancy estimator 22. These constraints may be based on physical dimensions associated with the building, information regarding the number of occupants allowed to occupy a particular region at a particular time, and information regarding the number of occupants allowed to transition between zones at a particular time. Constraints defining the maximum or minimum number of occupants allowed in a zone at a particular time are defined as hard constraints that must be met as part of the constrained optimization algorithm.

For instance, each region (e.g., room, zone) can be characterized by upper and lower bounds on occupancy. An occupancy lower bound XLB may be defined as zero, meaning that a room cannot have less than zero occupants at any given time. An occupancy upper bound XUB can be defined as any non-zero number, wherein the upper bound is likely dependant on the number of occupants that can be expected or physically able to fit within a particular room or zone. Likewise, upper and lower bounds RUB, RLB can be defined for occupant transitions between zones. In this case, if occupant transitions from a first zone to a second zone represent a positive transition, then occupant transitions from the second zone to the first zone may be represented as a negative transition. The transition lower bound RLB may therefore be represented as a negative number representing the number of occupants capable of transitioning between two zones over a defined period of time. The transition upper bound RUB may be represented as a positive number (mirroring the negative number for the same zones) representing an upper limit on the number of occupants capable of transitioning between two zones over a defined period of time. In addition to these constraints, additional constraints such as mass-balance constraints used to ensure conservation of occupants may be imposed by occupancy estimator 22.

Other constraints, defined generally as soft-constraints, are modeled by penalty functions incorporated within the constrained optimization algorithm employed by occupancy estimator 22. The soft constraints are used to incorporate forecasts, although not necessarily required, regarding likely occupant movements. For instance, a penalty function may define a soft constraint against sudden changes in occupancy (as measured with respect to adjacent time steps) associated with a particular zone or room.

Utility function u(t) is described broadly as prior knowledge that can be used to augment the sensor data and model to provide more accurate estimates of occupancy and flow. Specifically, utility function u(t) may represent prior knowledge regarding how a particular zone or region is to be utilized. For instance, utility function u(t) may employ prior knowledge regarding whether a room is an office room or a conference room, with a conference room being described by a utility function that defines a likely occupancy level that is greater than a utility function associated with an office.

Utility function u(t) may also incorporate prior knowledge regarding the sensor model. For instance, knowledge regarding the use of a motion detector sensor only capable of providing a binary output (occupied or un-occupied) can be included within the utility function to estimate the likely number of occupants in a room based on the sensor detecting that the room is occupied. Utility function u(t) could therefore incorporate information regarding the sensor model (e.g., motion sensor) as well as the type of room in which the sensor model is located (e.g., conference room), and assign a likely occupancy that is based on prior knowledge of the sensor as well as the utility of the room (e.g., detected occupation in a conference room may have a higher likely occupancy than a detected occupation in an office room).

Utility function u(t) may also include specific data regarding how a zone or region is going to be used at a particular time. For instance, utility function u(t) may include information regarding a meeting scheduled with respect to a particular room at a particular time, as well as information regarding the number of occupants invited to the meeting. In this way, the utility function u(t) provides information that can be used as another input in estimating occupancy.

Utility function u(t) may also be augmented by occupancy estimates x(t) and flow estimates R(t) generated by occupancy estimator 22 over a period of time (e.g., several days or weeks). In this way, observed occupancy is incorporated as prior knowledge that is used to improve subsequent estimates of occupancy x(t) and flow R(t). For instance, detected occupancy in an office room from 9 am to 5 pm on Monday through Friday can be incorporated into a utility function u(t) that describes a likely occupancy associated with the room depending on the day of the week and the time of day.

Building information 34 describes the layout of a particular building, including connections between adjacent zones, location of entrances and exits, and locations of sensors distributed throughout the region. Building information and constraint data are closely related, as constraint data may depend in large part on the physical dimensions of the region or building being modeled. In addition, both constraint data and building information are typically modeled or selected by an administrator during set-up of estimation system 20 and do not vary over time (in contrast with sensor data y(t) and utility information u(t) which typically will vary with time). The constraint inputs and the building information inputs are described as separate entities to distinguish between data used specifically to constrain the optimization algorithm employed by occupancy estimator 22 and information (such as which zones are connected to one another) that are used to frame and define the optimization problem.

### Constrained Optimization by the Occupancy Estimator

In response to the inputs discussed above, occupancy estimator 22 generates real-time estimates of occupancy x(t) and flow R(t). As alluded to earlier, occupancy estimator 22 employs a constrained optimization algorithm to compute, based on the provided inputs, an estimate of occupancy x(t) and flow R(t), subject to the defined constraints. As part of this process, an objective function is described that compares inputs provided by the sensors with the estimates of occupancy x(t) and flow R(t). The values associated with the occupancy estimates x(t) and flow estimates R(t) are computed, subject to a plurality of constraints, such that the output of the objective function is minimized. By minimizing the result of the objective function, the computed values associated with occupancy x(t) and flow R(t) represent the most likely values associated with occupancy and occupant movement within the region. In addition, prior knowledge associated with sensor data, building layout, and building utilization information is included as part of the objective function to improve the accuracy of the occupancy estimates x(t) and flow estimates R(t).

In an exemplary embodiment, the objective function is described as follows:

$$min {‖ φ ( 0 ) - \overline{φ} ( 0 ) ‖}_{{\sum }_{0}^{- 1}}^{2} + {\sum }_{t = 0}^{T - 1} ( {‖ y ( t ) - R ( t ) ‖}_{{\sum }_{y}^{- 1}}^{2} + {‖ x ( t + 1 ) - x ( t ) ‖}_{{\sum }_{x}^{- 1}}^{2} + {‖ R ( t + 1 ) - R ( t ) ‖}_{{\sum }_{d}^{- 1}}^{2} - u ( t ) ) \qquad Eq . 2$$

In this embodiment, the term ∥φ(0)− φ̅(0)∥_{Σ}_{₀}_{^{−1}}² measures the difference between an initial estimate of occupancy and flow (represented as a single variable φ) with an initial guess of occupancy and flow (represented as a single variable φ̅) subject to a weighting factor described by the term Σ₀⁻¹. This term is most commonly generated at a time t in which initial estimates of occupancy are well-known. For instance, for an office building these estimates may be generated at a time t corresponding with a time in which nobody is in the office.

The term

$${\sum }_{t = 0}^{T - 1} {‖ y ( t ) - R ( t ) ‖}_{{\sum }_{y}^{- 1}}^{2}$$

measures the penalty associated with model and sensor consistency by comparing the difference between sensor data y(t) and flow estimates R(t) subject to a weighting factor Σ_{y}⁻¹ for time periods t=0, . . . , T−1. This term is described as a ‘penalty function’ because differences between the sensor readings of flow and the model-based estimate of flow result in a non-negative value that acts as a penalty to the goal of minimizing the objective function.

The term

$${\sum }_{t = 0}^{T - 1} ( {‖ x ( t + 1 ) - x ( t ) ‖}_{{\sum }_{x}^{- 1}}^{2} + {‖ R ( t + 1 ) - R ( t ) ‖}_{{\sum }_{d}^{- 1}}^{2} )$$

measures the penalty associated with model dynamics (i.e., functions used to model soft-constraints describing likely, although not required, occupant movements). In this embodiment, a first penalty function measures the differences between occupancy estimates x(t) for adjacent time periods t+1 and t and a second penalty function that measures the difference between flow estimates R(t) for adjacent time periods t+1 and t. These functions are once again described as penalty functions. In particular, the term ∥x(t+1)−x(t)∥²_{Σ}_{ₓ}_{^{−1}} is a penalty function that models a so-called soft constraint against sudden changes in occupancy. That is, this term assesses a penalty to sudden changes in occupancy from time t to time t+1. Likewise, the term ∥R(t+1)−R(t)∥²_{Σ}_{_{d}}_{^{−1}} is a penalty function that models a so-called soft constraint against sudden changes in flow between adjacent time steps. In this way, the objective function incorporates model dynamics that seek to maintain consistency between computed occupancy estimates and real-world expectations of occupancy movement.

The term

$${\sum }_{t = 0}^{T - 1} u ( t )$$

is the utility function, which takes into account prior knowledge (as described above) that is used to augment and improve occupancy estimates. For example, the utility function u(t) may take into account with respect to sensor data y(t) provided by a motion sensor detector the likelihood of more than one occupant being located in the region. With respect to a region or room utilized as an office, detection of movement by a motion sensor detector may indicate the likely presence of a single occupant in the room. In contrast, detection of movement by a motion sensor detector in a room utilized as a conference room may indicate the likely presence of multiple occupants in the room. In this way, utility function u(t) facilitates determinations regarding occupancy and flow based on how a particular region or room is utilized, in conjunction with the type of sensor data provided for the corresponding region or room. As discussed above, utility function u(t) may also take into account specific information regarding the utilization of a room such as knowledge regarding a scheduled meeting. For example, a utility function for a large conference room with reservation x⁰ may take the following form:

$$u ( x ) = \{ \begin{matrix}- {a}^{1} x + {b}^{1} , x \geq {x}^{0} \\ {a}^{2} x + {b}^{2} , 0 \leq x \leq {x}^{0}\end{matrix} \qquad Eq . 3$$

where −a¹x⁰+b¹=a²x⁰+b² and a¹, b¹, a², b²>0.

In this way, the utility function described by Eq. 3 provides an output that is dependent on the occupancy estimate x(t) (i.e., calculates the top function if the occupancy estimate is greater than the expected or reserved occupancy, the bottom function if the occupancy estimate is less than the expected or reserved occupancy) that is taken into account when computing an occupancy and flow estimate that minimizes the objective function.

The constrained optimization algorithm computes occupancy estimates x(t) and flow estimates R(t) by minimizing the objective function (e.g., Eq. 2). However, the computed occupancy estimate x(t) and flow estimate R(t) must be solved subject to one or more hard constraints, examples of which are provided below. In an exemplary embodiment, the constraints (i.e., hard constraints, used to distinguish from the term soft constraints used to define model dynamics) defined with respect to the objective function described in Equation 2 are defined as follows.

Mass-Balance Constraint: x(t+1)=x(t)+[R^{T}(t+1)−R(t+1)]·1 Eq. 4

Upper, Lower Bound on Occupancy: XLB(t)≦x(t)≦XUB(t),∀t Eq. 5

Upper, Lower Bound on Flow: −RUB(t)≦R(t)≦RUB(t),∀t Eq. 6

The mass-balance constraint (Eq. 4) ensures that for selected estimations of occupancy x(t) and flow R(t), the estimate of occupancy for a subsequent time period x(t+1) equals the occupancy level at time t plus the net flow of occupants (i.e., both entering R^{T}(t+1) and leaving R(t+1)) into the zone at time t, wherein the term ‘1’ is a vector of ones. This ensures that each occupant is accounted for at each time step.

The upper and lower bound constraint on occupancy (Eq. 5) ensures that a selected estimate of occupancy x(t) falls within a specific allowable range. For example, the lower bound of the occupancy range may be defined such that a room cannot have a negative occupancy. The upper bound of the occupancy range may be defined based on known data associated with the room, such as the physical dimensions of the room, number of chairs located in the room, or some other factor used to determine the maximum number of occupants that may be modeled as located in a particular zone or region. Likewise, the upper and lower bounds on flow estimates R(t) (Eq. 6) ensure that a selected flow estimate falls within a specific allowable range. In this embodiment, the lower bound on flow is the negative (inverse) of the upper bound for flow, indicating that the maximum allowable flow of occupants in one direction is equal to the maximum allowable flow of occupants in the opposite direction. Once again, the value selected to define the upper and lower bound of flow may be dictated by physical dimensions of the zone or region (e.g., hallway) connecting two zones.

In this way, occupancy estimator 22 generates occupancy estimates x(t) and occupant flow estimates R(t) using constrained optimization in which the output of an objective function, defined by penalty functions that measure sensor and occupancy estimate and/or flow estimate consistency, penalty functions that measure model dynamics (e.g., soft-constraints on changes in occupancy and flow), and utility functions representing prior knowledge associated with the region, is minimized based on the computed values associated with occupancy x(t) and flow R(t), subject to one or more constraints regarding allowable values of each estimate. As a result of the constrained optimization, occupancy estimator 22 generates occupancy estimates x(t) and occupant flow estimates R(t) that represent real-time estimates of the number of occupants located in each zone/room of a region and the number of occupants transitioning between adjacent zones at time t, respectively.

In an exemplary embodiment, real-time occupant estimates x(t) and flow estimates R(t) are provided as inputs to control system 36, which may include a variety of individual control systems depending on the application. For instance, control system 36 may include an HVAC controller that operates to control environmental conditions (e.g., temperature, humidity, etc.) associated with the building based on estimated positions of occupants. In other embodiments, control system 36 may include an elevator dispatch controller for controlling the dispatch of elevator cabs in response to occupant and flow estimates (e.g., detection of an occupant transitioning toward an elevator hall). Other controllable systems may include lighting systems for automatically turning on and off lights based on the detection of occupants. These systems may be based solely on occupant estimates x(t), flow estimates R(t), or a combination thereof.

In addition, occupancy estimates x(t) and flow estimates R(t) are provided as input to parameter estimator 24, to be analyzed and used in conjunction with statistical model 26 to generate a conditional probability distribution P(X) representing normal traffic patterns associated with the region.

### Parameter Estimation and Statistical Model

Parameter estimator 24 generates parameter estimates based on the application of statistical models of occupancy and flow to data samples represented by occupancy and flow estimates provided by occupancy estimator 22. Parameter estimates describe probabilistic laws associated with occupant movements (e.g., arrivals and transitions) within a region. Probability distributions and the resulting parameter estimates generated by parameter estimator 24 provide a framework for deriving the normal traffic pattern of occupants (i.e., conditional probability distribution P(X)) based on a sample of measured events (i.e., occupant estimates x(t) and flow estimates R(t)). In particular, the conditional probability distribution P(X) for a particular zone represents the probability of zone i taking different levels of occupancy at a current time step, conditioned on the occupancy levels in zone i and zones neighboring zone i at a previous time step(s). The term P(Xᵢ), i=1, 2, . . . N represents the conditional probability associated with each zone (total of N zones) located in the region.

Different types of probability distributions are used based on the type of occupant behavior to be modeled. For instance, occupant arrivals to a region via an entrance are described by a one-sided distribution such as a truncated Poisson distribution. In contrast, occupant transitions between zones, which may include occupants entering and leaving a particular zone, are described by a two-sided distribution such as a truncated two-sided geometric distribution. Based on the selected distribution, parameters associated with observed events can be estimated.

Parameter Estimation for Arrival Distributions

Parameter estimation for arrival distributions employs flow estimates R(t) and occupant estimates x(t) provided by occupancy estimator 22 to derive an arrival parameter estimate that defines a probabilistic arrival law of occupant arrivals to a zone within the region. In an exemplary embodiment, the distribution used to describe the arrival of occupants into a zone is the truncated Poisson distribution, which is defined by the following equation:

$$P ( {A}_{ij}^{1} = k \vert {x}_{i}^{0} = q ) = \{ \begin{matrix}F ( q ) \frac{{λ}_{T}^{k} {e}^{- {λ}_{T}}}{k !} , & k < {XUB}_{i} - q \\ 0 , & k \geq {XUB}_{i} - q\end{matrix} , j = 1 , 2 , , … , {N}_{a} \qquad Eq . 7$$

Aᵢⱼ¹—Number of arrivals from entrance j into zone i at time 1
xᵢ⁰—Zone occupancy in zone i at time 0
XUBᵢ—Occupancy upper bound for zone i
Nₐ—Total number of entrances
F(q)—Normalization factor calculated as part of the parameter estimation
λ_{T}—Flow parameter estimated based on the arrival distribution.
   The variable k represents the number of occupants entering zone i from entrance j for a given time period. Similarly, the variable q represents the number of occupants located in zone i. The probability associated with k occupant arrivals given the occupancy level q is defined by the function

$$F ( q ) \frac{{λ}_{T}^{k} {e}^{- {λ}_{T}}}{k !}$$

when the number of occupants k entering the zone is less than the upper bound of occupants defined for the zone, XUBᵢ, less the number of occupants already located in the zone q (i.e., meaning there is room for additional occupants to enter the zone via the entrance). Otherwise, the probability associated with an occupant arrival is zero (i.e., when the number of occupants q located in the zone is greater than or equal to the upper bound of occupants XUBᵢ defined for the zone). The parameter λ_{T} defines the expected flow of occupants into the zone, and is calculated based on the following equation:

$${e}^{{λ}_{T}} {λ}_{T} = \frac{E ( {A}_{ij}^{1} I ( {A}_{ij}^{1} > 0 ) \vert {x}_{i}^{0} = q )}{P ( {A}_{ij}^{1} = 0 \vert {x}_{i}^{0} = q )} \approx \frac{{\sum }_{k = 0}^{N - 1} {A}_{ij} ( k + 1 ) I ( {A}_{ij} ( k + 1 ) > 0 ) I ( {x}^{i} ( k ) ∈ {L}^{i} )}{{\sum }_{k = 0}^{N - 1} I ( {A}_{ij} ( k + 1 ) = 0 ) I ( {x}^{i} ( k ) ∈ {L}^{i} )} \qquad Eq . 8$$

The function I( ) represents an indicator function defined on the set Lⁱ, wherein Lⁱ is a subset spanning the whole range of occupancy level allowed for that zone.

In addition to the flow parameter λ_{T}, a normalization parameter F(q) is calculated based on Eq. 7 to ensure the sum of probability function P(A|x) equals unity. In this way, parameter estimates describing the arrival of occupants to a particular zone (from a plurality of possible entrances) for a given period of time can be estimated based on the occupancy and flow estimates provided by occupancy estimator 22. As described in more detail below, these parameters are employed by statistical model 26 to calculate a conditional probability distribution P(Xᵢ), i=1, 2, . . . N describing normal traffic flow associated with a particular region or building.

Parameter Estimation for Transition Distributions

Parameter estimation for transition distributions employs occupancy estimates x(t) and flow estimates R(t) to derive a transition parameter estimate that defines a probabilistic transition law of occupants between regions. In an exemplary embodiment, the distribution used to describe the transition of occupants between zones is the truncated two-sided geometric distribution, which is defined by the following equation:

P_{T}(Rᵢⱼ¹=m|xᵢ⁰=q₁, xⱼ⁰=q₂)=p_{T}⁰I(0)+F(q₁,q₂)[P_{T}⁺(m)I(m>0)+P_{T}⁻(m)I(m<0)] Eq. 9

wherein the probabilities P_{T}⁺(m), P_{T}⁻(m) are defined by the following conditions:

$$\begin{matrix}{RUB}^{+} ( {q}_{1} {q}_{2} ) = min ( {q}_{2} , {XUB}_{i} - {q}_{1} ) & Eq . 10 \\ {RUB}^{-} ( {q}_{1} , {q}_{2} ) = min ( {q}_{1} , {XUB}_{j} - {q}_{2} ) & Eq . 11 \\ {P}_{T}^{\pm } ( k ) = \{ \begin{matrix}{( 1 - {p}_{T}^{\pm } )}^{\pm k} {p}_{T}^{\pm } , & 1 \leq \vert k \vert \leq {RUB}^{\pm } ( {q}_{1} , {q}_{2} ) \\ 0 , & \vert k \vert > {RUB}^{\pm } ( {q}_{1} , {q}_{2} )\end{matrix} & Eq . 12\end{matrix}$$

Rᵢⱼ¹—Number of transitions between zone i and zone j
xᵢ⁰—Zone occupancy in zone i at time 0
xⱼ⁰—Zone occupancy in zone j at time 0
p_{T}⁰—probability of zero transitions between zones i and j
p_{T}⁺—parameter estimate indicating occupants transitioning into zone i
p_{T}⁻—parameter estimate indicating occupants transitioning out of zone i
RUB⁺(q1, q2)—limit on number of occupants able to transition into zone i
RUB⁻(q1, q2)—limit on number of occupants able to transition out of zone i
XUBᵢ—Occupancy upper bound for zone i
XUBⱼ—Occupancy upper bound for zone j
F(q₁, q₂)—Normalization factor
   The variable m represents number of occupants transitioning from zone i to zone j at a given time. Similarly, the variables q₁ and q₂ represent the number of occupants located in zones i and j, respectively. The probability distribution P(R|x₁, x₂), defined by Eq. 9-12, describes the probability associated with an occupant transitioning between adjacent zones based on sample data represented by occupant estimates x(t) and R(t) provided by occupancy estimator 22. In particular, Eq. 9-12 illustrate the dependency of the transition probability functions P_{T}⁺(k) and P_{T}⁻(k) on the number of occupants q₁, q₂ estimated to occupy each zone, as well as the upper bounds of occupancy XUBᵢ, XUBᵢ defined for each zone.

Based on the probability distribution associated with occupant transitions defined by Eq. 9, parameter estimates modeling the expected or normal flow of occupants (e.g., parameters p_{T}⁺, p_{T}⁻ and p_{T}⁰ can be derived based on the following equations:

$$\begin{matrix}\frac{1}{{p}_{T}^{+}} = \frac{E ( {R}_{ji}^{1} I ( {R}_{ji}^{1} > 0 ) \vert {x}_{i}^{0} = {q}_{1} , {x}_{j}^{0} = {q}_{2} )}{{P}_{T} ( {R}_{ji}^{1} > 0 \vert {x}_{i}^{0} = {q}_{1} , {x}_{j}^{0} = {q}_{2} )} \approx \frac{{\sum }_{k = 0}^{N - 1} {R}_{ji} ( k + 1 ) I ( {R}_{ji} ( k + 1 ) > 0 ) I ( {x}_{i} ( k ) ∈ {L}^{i} ) I ( {x}_{j} ( k ) ∈ {L}^{j} )}{{\sum }_{k = 0}^{N - 1} I ( {R}_{ji} ( k + 1 ) > 0 ) I ( {x}_{i} ( k ) ∈ {L}^{i} ) I ( {x}_{j} ( k ) ∈ {L}^{j} )} & Eq . 13 \\ \frac{1}{{p}_{T}^{-}} = \frac{E ( {R}_{ji}^{1} I ( {R}_{ji}^{1} < 0 ) \vert {x}_{i}^{0} = {q}_{1} , {x}_{j}^{0} = {q}_{2} )}{{P}_{T} ( {R}_{ji}^{1} < 0 \vert {x}_{i}^{0} = {q}_{1} , {x}_{j}^{0} = {q}_{2} )} \approx \vert \frac{{\sum }_{k = 0}^{N - 1} {R}_{ji} ( k + 1 ) I ( {R}_{ji} ( k + 1 ) < 0 ) I ( {x}_{i} ( k ) ∈ {L}^{i} ) I ( {x}_{j} ( k ) ∈ {L}^{j} )}{{\sum }_{k = 0}^{N - 1} I ( {R}_{ji} ( k + 1 ) < 0 ) I ( {x}_{i} ( k ) ∈ {L}^{i} ) I ( {x}_{j} ( k ) ∈ {L}^{j} )} \vert & Eq . 14 \\ {p}_{T}^{0} = {P}_{T} ( {R}_{ji}^{1} = 0 \vert {x}_{i}^{0} = {q}_{1} , {x}_{j}^{0} = {q}_{2} ) \approx \frac{{\sum }_{k = 0}^{N - 1} I ( {R}_{ij} ( k + 1 ) = 0 ) I ( {x}_{i} ( k ) ∈ {L}^{i} ) I ( {x}_{j} ( k ) ∈ {L}^{j} )}{{\sum }_{k = 0}^{N - 1} I ( {x}_{i} ( k ) ∈ {L}^{i} ) I ( {x}_{j} ( k ) ∈ {L}^{j} )} & Eq . 15\end{matrix}$$

Once again, the function I( ) represents an indicator function defined on the set Lⁱ, wherein Lⁱ is a subset spanning the whole range of occupancy level allowed for that zone.

In addition to the transition parameters p_{T}⁺, p_{T}⁻ and p_{T}⁰, a normalization parameter F(q₁, q₂) is calculated based on Eq. 9 to ensure the sum of probability function P(R|x₁, x₂) equals unity. In this way, parameter estimates describing the transition of occupants between zones for a given period of time can be estimated based on the occupancy and flow estimates provided by occupancy estimator 22. As described in more detail below, these parameters are employed by statistical model 26 to calculate a conditional probability distribution P(X) describing normal traffic flow associated with a particular region or building.

Statistical Model

Statistical model 26 receives the parameter estimates generated by parameter estimator 24 based on arrival and transition distributions discussed above. In response to these inputs, statistical model 26 generates a conditional probability distribution P(Xᵢ), i=1, 2, . . . N that describes normal traffic patterns associated with the region. That is, as defined by the parameter estimates provided by parameter estimator 24, conditional probability P(Xᵢ) represents the probability of zone i taking different values of occupancy at a current time step, conditioned on the occupancy levels in zone i and zones neighboring zone i at previous time steps. In an exemplary embodiment, statistical model 26 employs a parameterized Markov model to generate the conditional probability distribution P(Xᵢ), as described by the following equation:

$$P ( {X}_{i} = p ) = \frac{1}{2 π} {\int }_{- π}^{π} {\prod }_{j - 1}^{{N}_{a}} {\overline{Φ}}_{{z}_{ij}} ( ω ) {\prod }_{j - 1}^{{N}_{i}} \overline{Φ} {R}_{ij} ( ω ) {e}^{iω ( p - q )} d ω \qquad Eq . 16$$

wherein Φ_{Zij}(ω) and Φ_{Yij}(ω) are Fourier representations of parameter estimates calculated by parameter estimator 24, as described by the following equations.

$$\begin{matrix} {Φ}_{{z}_{ij}} ( ω ) = F ( q ) {e}^{- {λ}_{T}} {\sum }_{n = 0}^{min ( 0 , {XUB}_{i} - q )} \frac{{( {e}^{iω} {γ}_{T} )}^{n}}{n !} & Eq . 17 \\ {Φ}_{{Y}_{ij}} ( ω ) = {p}_{T}^{0} + F ( {q}_{1} , {q}_{2} ) ( {p}_{T}^{+} ( 1 - {p}_{T}^{+} ) {e}^{iω} \frac{[ {( ( 1 - {p}_{T}^{+} ) {e}^{iω} )}^{{B}^{+}} - 1 ]}{[ ( 1 - {p}_{T}^{+} ) {e}^{iω} - 1 ]} + {p}_{T}^{-} ( 1 - {p}_{T}^{-} ) {e}^{- iω} \frac{[ {( ( 1 - {p}_{T}^{-} ) {e}^{- iω} )}^{{B}^{-}} - 1 ]}{[ ( 1 - {p}_{T}^{-} ) {e}^{- iω} - 1 ]} ) & Eq . 20\end{matrix}$$

The conditional probability distribution P(X) is not modeled on sensor data provided by distributed sensor network 28, but rather on the occupancy and flow estimates generated by occupancy estimator 22.

While conditional probability distribution P(Xᵢ), i=1, 2, . . . N is based on occupancy and flow estimates (as opposed to sensor data directly), the distribution mimics the observed measurements associated with occupant movements. Based on accumulated occupancy estimates and flow estimates describing the movement of occupants throughout the region, conditional probability distribution P(X) will represent the normal traffic pattern of occupants within the region.

Conditional probability distributions P(X) can be provided as an input to a number of systems, both for real-time analysis and forensic purposes. For instance, having defined a normal traffic pattern based on accumulated or legacy occupant estimates, a conditional probability distribution P(X) calculated based on current traffic patterns can be used to detect anomalies in occupant behavior. This may include a simple comparison of the legacy conditional probability distribution to the current conditional probability distribution based on some threshold, or may include more specific analysis regarding distributions associated with occupant arrivals and transitions between individual zones. For instance, if a previously calculated conditional probability distribution P(X) defines normal traffic patterns of occupants, in which occupants move in a predictable manner between zones based on the time of day (e.g., occupants enter a building around 9 am, exit the building around noon, return to the building at 1 pm, and exit again around 5 pm), a conditional probability distribution P(X) based on current occupancy estimates that describes a number of occupants entering the building at 10 pm presents an anomaly that may be indicative of security threat (e.g., a break-in).

In other embodiments, conditional probability distribution P(X) describing normal traffic patterns can be utilized for forensic purposes for clues regarding how occupants move through a region. For instance, this type of analysis may be useful in designing buildings to promote efficient traffic of occupants. This type of analysis may similarly be useful for building intelligence purposes such as determining how occupants move through a mall (i.e., entrance most often used, highest foot-traffic areas, lowest foot-traffic areas, etc.)

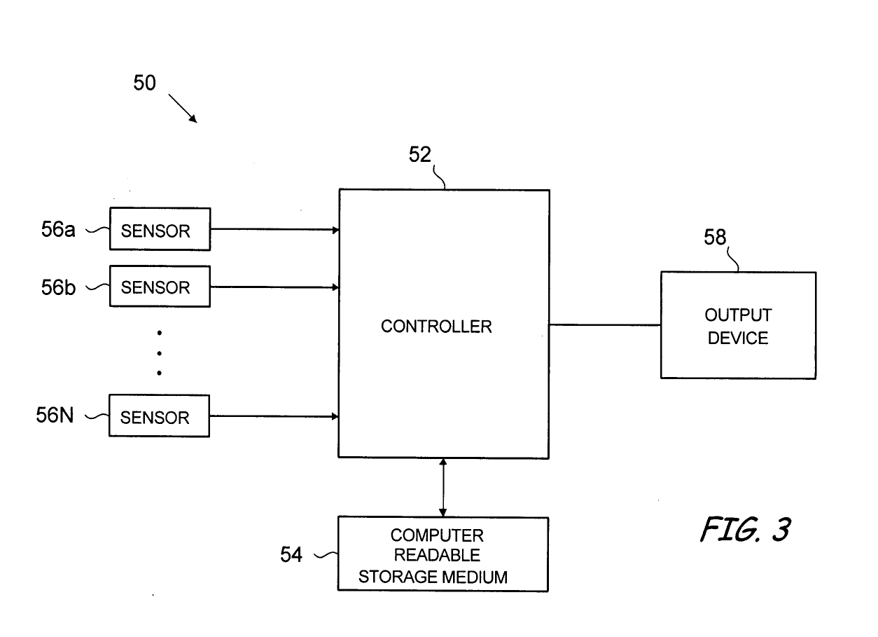

FIG. 3 illustrates an exemplary embodiment of a centralized system 50 for providing occupancy estimations for a region (e.g., each zone of the building as shown in FIGS. 1A and 1B). Centralized system 50 includes computer or controller 52, computer readable medium 54, a plurality of heterogeneous sensor devices 56a, 56b, . . . 56N, and output device 58. Sensor devices 56a-56N are distributed throughout a particular region, and may include a variety of different types of sensors, including video cameras, passive infrared motion sensors, access control devices, CO₂ sensors, elevator load measurements, IT-related techniques such as detection of computer keystrokes, as well as other related sensor devices. In addition, many occupants carry active devices, such as active or passive radio frequency identification (RFID) cards, cell phones, or other devices that can be detected to provide sensor data.

The sensor data is communicated to computer or controller 52. Depending on the type of sensors employed, and whether the sensors include any ability to process captured data, computer 52 may provide initial processing of the provided sensor data. For instance, video data captured by a video camera sensing device may require some video data analysis pre-processing to determine whether the video data shows occupants traversing from one zone to another zone. In addition, this processing performed by processor 52 may include storing the sensor data, indicating detected occupants moving between zones, to an array or vector such that it can be supplied as an input to a constrained optimization algorithm (described with respect to FIG. 2) executed by controller 52. In addition, controller 52 may include memory or storage devices for storing additional inputs to the constrained optimization algorithm, such as the constraints, building information, and utility functions described with respect to FIG. 2.

In response to these inputs, controller 52 implements the functions described with respect to FIG. 2 to generate real-time occupancy estimates, flow estimates and conditional probability distributions describing traffic patterns associated with the region. Thus, the disclosed invention can be embodied in the form of computer or controller implemented processes and apparatuses for practicing those processes. The present invention can also be embodied in the form of computer program code containing instructions embodied in computer readable medium 54, such as floppy diskettes, CD-ROMs, hard drives, or any other computer-readable storage medium, wherein, when the computer program code is loaded into and executed by controller 52, the controller becomes an apparatus for practicing the invention. The present invention may also be embodied in the form of computer program code as a data signal, for example, whether stored in a storage medium 54, loaded into and/or executed by a computer or controller 52, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

For example, in an embodiment shown in FIG. 3, computer readable storage medium 54 may store program code or instructions describing the constrained optimization algorithm, parameter estimation algorithm, and parameterized Markov model for generating occupant traffic distributions. The computer program code is communicated to computer or controller 52, which executes the program code to implement the processes and functions described with respect to the present invention (e.g., executing those functions described with respect to FIG. 2).

As shown in FIG. 3, computer or controller 52 generates an output that is provided to output device 58. The output may include both real-time occupancy and flow estimates describing the current location of movement of occupants within the region, or may include the conditional probability distribution describing, (based on the occupancy and flow estimates) the movement of occupants within the region.

In other embodiments, the functions performed by controller 52 may be distributed to a plurality of local devices. For instance, in an exemplary embodiment, each sensor device includes processing capability that allows it to estimate the location and flow of occupants using the constrained optimization problem described with respect to FIG. 2. In addition, in a distributed processing system, each sensor may be connected to receive additional data from other sensors. For instance, a sensor connected to monitor occupancy in a particular zone may be connected to a sensors located in adjacent zones for monitoring occupancy. The sensor in the primary zone calculates occupancy and flow estimates based, in part, on occupancy and flow estimates calculated for adjacent zones. A benefit of employing distributed systems for providing occupancy estimates is the ability of distributed systems to function despite the loss of one or more of the distributed systems.

Although the present invention has been described with reference to preferred embodiments, workers skilled in the art will recognize that changes may be made in form and detail without departing from the spirit and scope of the invention. For example, although a computer system including a processor and memory was described for implementing the occupancy estimation algorithm, any number of suitable combinations of hardware and software may be employed for executing the mathematical functions employed by the occupancy estimation algorithm. In addition, the computer system may or may not be used to provide data processing of received sensor data. In some embodiments, the sensor data may be pre-processed before being provided as an input to the computer system responsible for executing the occupancy estimation algorithm. In other embodiments, the computer system may include suitable data processing techniques to internally process the provided sensor data.

Furthermore, throughout the specification and claims, the use of the term ‘a’ should not be interpreted to mean “only one”, but rather should be interpreted broadly as meaning “one or more”. The use of sequentially numbered steps used throughout the disclosure does not imply an order in which the steps must be performed. The use of the term “or” should be interpreted as being inclusive unless otherwise stated.

1. A system for estimating occupancy in a region, the system comprising:
a first input operably connected to receive sensor data from one or more sensor devices;
a second input operably connected to receive constraints;
a third input operably connected to receive utility functions;
an occupancy estimator operably connected to the first input, the second input, and the third input, wherein the sensor data, the utility functions, and an occupancy estimate are organized into an objective function, wherein the occupancy estimator executes a constrained optimization algorithm that computes the occupancy estimate, subject to the constraints, such that the objective function is minimized; and
an output operably connected to the occupancy estimator to communicate the occupancy estimate generated by the occupancy estimator.

2. The system of claim 1, wherein the utility function describes a likely occupancy level associated with a zone within the region based on prior knowledge associated with how the zone will be utilized.

3. The system of claim 1, wherein the utility function describes a likely occupancy level associated with a zone within the region based on prior knowledge of scheduled events associated with the zone.

4. The system of claim 1, wherein the utility function describes a likely occupancy level for a zone within the region based on prior knowledge associated with a sensor model associated with the zone.

5. The system of claim 1, wherein the utility function describes a likely occupancy level for a zone within a region based on prior knowledge collected from previous occupancy estimates computed the occupancy estimator for the zone.

6. The system of claim 1, further including:
a fourth input operably connected to receive building information, wherein the objective function is organized based, in part, on the received building information.

7. The system of claim 1, wherein the objective function further includes a flow estimate that represents the number of occupants transitioning between adjacent zones, wherein the occupancy estimator executes a constrained optimization algorithm that computes the flow estimate, subject to the constraints, such that the objective function is minimized.

8. The system of claim 7, wherein the constraints define an occupancy minimum and maximum for each zone in the region and a flow minimum and maximum for the transition of occupants between adjacent zones within the region.

9. The system of claim 7, wherein the objective function includes a first penalty function that measures consistency between the sensor data and the flow estimate.

10. The system of claim 9, wherein the objective function includes a second penalty function that models a soft-constraint on changes in the occupancy estimate for adjacent time steps.

11. The system of claim 10, wherein the objective function includes a third penalty function that models a soft-constraint on changes in the flow estimate for adjacent time steps.

12. The system of claim 1, further including:
a parameter estimator operably connected to the output for receiving the occupancy estimates generated by the occupancy estimator, wherein the parameter estimator applies a statistical distribution to the occupancy estimate to generate parameter estimates; and
a statistical distribution generator operably connected to receive the parameter estimates generated by the parameter estimator and to generate in response to the parameter estimates a conditional probability distribution that represents a probability of a particular zone within the region having various levels of occupancy at a current time step, conditioned on occupancy estimate of the particular zone and zones neighboring the particular zone at a previous time step.

13. The system of claim 12, wherein the parameter estimator applies a one-sided truncated Poisson distribution to the occupancy estimates to generate a parameter estimate associated with arrivals of occupants to a zone within the region.

14. The system of claim 12, wherein the parameter estimator applies a two-sided truncated geometric distribution to the occupancy estimates to generate a parameter estimate associated with transitions of occupants between zones within the region.

15. The system of claim 12, wherein the statistical distribution generator employs a parameterized Markov model to generate the conditional probability distribution based on the parameters estimates provided by the parameter estimator.

16. The system of claim 1, wherein the system is a centralized system in which the occupancy estimator is operably connected to receive data from a plurality of heterogeneous sensors located throughout the region and in response generates occupancy estimates for each zone within the region.

17. The system of claim 1, wherein the system is a distributed system including a plurality of occupancy estimators, wherein each of the plurality of occupancy estimators receives sensor data associated with a proximate location of the region and executes a constrained optimization algorithm to generate an occupancy estimate for the proximate location based on the received sensor data, a utility function and constraints associated with the proximate location.

18. A method for monitoring occupancy in a region, the method comprising:
acquiring sensor data from one or more sensor devices;
computing an occupancy estimate that minimizes a result of an objective function, wherein the objective function is organized to compare a penalty associated with differences in the sensor data and the occupancy estimate with a utility function that describes a likely occupancy level; and
generating an output that provides the occupancy estimate to one or more control and/or monitoring systems.

19. The method of claim 18, wherein the occupancy estimate includes a flow estimate that is computed as part of the objective function, wherein the flow estimate represents a number of occupants transitioning between adjacent zones within the region.

20. The method of claim 19, wherein computing the occupancy estimate includes computing the occupancy estimate and/or the flow estimate to satisfy one or more constraints that define occupancy minimums and maximums for each zone in the region and flow minimums and maximums defined for the transition of occupants between adjacent zones within the region.

21. The method of claim 19, wherein the objective function includes a first penalty function that measures consistency between the sensor data and the flow estimate, a second penalty function that models a soft-constraint on changes in the occupancy estimate between adjacent time periods, and third penalty function that models a soft-constraint on changes in the flow estimate between adjacent time periods.

22. The method of claim 19, further including:
calculating a parameter estimate associated with occupant movements within the region by applying a statistical distribution to the computed flow estimates and/or the computed occupancy estimates; and
generating a conditional probability distribution based on the calculated parameter estimate, the conditional probability distribution representing a probability of a particular zone within the region having various levels of occupancy at a current time step, conditioned on occupancy estimate of the particular zone and zones neighboring the particular zone at a previous time step; and
providing as an output the computed occupancy estimate, the computed flow estimate, and the conditional probability distribution.

23. The method of claim 19, wherein calculating a parameter estimate includes:
applying a first statistical distribution to the computed occupancy estimates and/or the computed flow estimates to calculate an arrival parameter that defines a probabilistic arrival law of occupants to the region; and
applying a second statistical distribution to the computed occupancy estimates and/or the computed flow estimates to calculate a transition parameter that defines a probabilistic transition law of occupants between regions.

24. The method of claim 23, wherein the first statistical distribution is a one-sided truncated Poisson distribution and the second statistical distribution is a two-sided geometric distribution.

25. The method of claim 22, wherein generating a conditional probability distribution based on the calculated parameter estimate includes applying a parameterized Markov model to the transition parameter estimate and the arrival parameter estimate.

26. A system for generating occupancy estimates for a region and conditional probability distributions defining occupant traffic in the region, the system comprising:
at least one sensor device for acquiring sensor data relevant to occupancy;
means for generating an occupancy estimate and/or flow estimate that executes a constrained optimization algorithm in conjunction with an objective function organized to compare the sensor data to the occupancy estimate and/or flow estimate, wherein the constrained optimization algorithm computes the occupancy estimate and/or flow estimate to minimize the result of the objective function, subject to a plurality of constraints on allowable levels of occupancy;
means for calculating an arrival parameter estimate associated with expected arrival of occupants to a zone within the region by applying a first statistical distribution to one or more calculated occupancy estimates and/or flow estimates and for calculating a transition parameter estimate associated with transition of occupants between zones in the region by applying a second statistical distribution to one or more calculated occupancy estimates and/or flow estimates;
means for generating a conditional probability distribution based on the calculated arrival parameter estimate and the calculated transition parameter estimate by applying a parameterized Markov model, wherein the conditional probability distribution represents a probability of a particular zone within the region having various levels of occupancy at a current time step, conditioned on occupancy estimate of the particular zone and zones neighboring the particular zone at a previous time step; and
means for providing as an output the occupancy estimate and/or flow estimate and the conditional probability distribution.

27. A computer readable storage medium encoded with a machine-readable computer program code for generating thereof occupancy estimates for a region and a conditional probability distribution describing normal occupant traffic for the region, the computer readable storage medium including instructions for causing a controller to implement a method comprising:
acquiring sensor data;
computing an occupancy estimate that minimizes a result of an objective function, wherein the objective function is organized to compare a penalty associated with differences in the sensor data and the occupancy estimate with a utility function that describes a likely occupancy level; and
generating an output that provides the occupancy estimate to selected systems within the region.

28. The computer readable storage medium of claim 27, the computer readable storage medium further including instructions for causing a controller to implement a method comprising:
calculating parameter estimates by applying a first statistical distribution to one or more computed occupancy estimates to generate a parameter estimate associated with occupant arrival to the region and a second statistical distribution to one or more computed occupancy estimates to generate a parameter estimate associated with occupant transitions between adjacent zones within the region; and
calculating a conditional probability distribution by applying a parameterized Markov model to the calculated parameter estimates, wherein the conditional probability distribution represents a probability of a particular zone within the region having various levels of occupancy at a current time step, conditioned on occupancy estimate of the particular zone and zones neighboring the particular zone at a previous time step; and
providing as an output the occupancy estimate and the conditional probability distribution.
